(19) United States
(12) Patent Application Publication
(10) Pub. No.: US 2005/0277332 A1
(43) Pub. Date: Dec. 15, 2005

(54) Surface mountable electrical connector

(76) Inventor: Marlon Chen, Taichung (TW)

Correspondence Address: CHRISTIE, PARKER & HALE, LLP, PO BOX 7068, PASADENA, CA, 91109-7068, US

(21) Appl. No.: 10/869,224

(22) Filed: Jun. 15, 2004

(51) Int. Cl. H01R 13/648

(52) U.S. Cl. 439/607

(57) ABSTRACT

A surface mountable electrical connector includes an insulative terminal housing, conductive terminals mounted on the housing, and a shielding cover surrounding the terminal housing and having a plurality of L-shaped surface mounting legs. Each of the surface mounting legs has a first segment that extends in a transverse direction relative to a printed circuit board, a bent segment that is bent from the first segment, and a second segment that extends from the bent segment and that is parallel to a planar surface of the printed circuit board. The bent segment has a width less than those of the first and second segments. The second segment has a free end that is distal from the bent segment, and is bifurcated to define a recess that extends inwardly from the free end of the second segment.

### BACKGROUND OF THE INVENTION

1. Field of the Invention

This invention relates to a surface mountable electrical connector, more particularly to a surface mountable electrical connector having bifurcated mounting legs that are adapted to be surface mounted on a printed circuit board.

2. Description of the Related Art

FIG. 1 illustrates a conventional surface mountable electrical connector 1, such as a USB connector, to be surface mounted on a planar surface of a printed circuit board (not shown). The electrical connector 1 includes a shielding cover 12 stamped and folded from a developed metal sheet, and an insulative terminal housing 11 received in the shielding cover 12 for receiving conductive terminals 13. The shielding cover 12 is formed with a plurality of L-shaped legs 123 which are required to be co-planar with the planar surface of the printed circuit board so as to be firmly fixed to the planar surface of the printed circuit board by soldering them together using surface mount technology (SMT). Since the legs 123 are bent from the developed metal sheet, there exists a relatively high stress in each of the legs 123, which can result in deformation of the legs 123, which, in turn, results in degradation of co-planarity of the legs 123. Moreover, there is still room for improving the amount of solder that can be soldered to each of the legs 123.

### SUMMARY OF THE INVENTION

The object of the present invention is to provide a surface mountable electrical connector that is capable of overcoming the aforesaid drawback associated with the prior art.

According to this invention, there is provided a surface mountable electrical connector that is adapted to be surface mounted on a printed circuit board. The surface mountable electrical connector comprises: an insulative terminal housing; a plurality of conductive terminals mounted on the housing; and a shielding cover surrounding the terminal housing and having a plurality of L-shaped surface mounting legs bent and extending outwardly therefrom. Each of the surface mounting legs has a first segment that extends in a transverse direction relative to the printed circuit board, a bent segment that is bent from the first segment, and a second segment that extends from the bent segment and that is adapted to be parallel and soldered to a planar surface of the printed circuit board. The bent segment has a width less than those of the first and second segments. The second segment has a free end that is distal from the bent segment, and is bifurcated to define a recess that extends inwardly from the free end of the second segment.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a perspective view of a conventional surface mountable electrical connector;

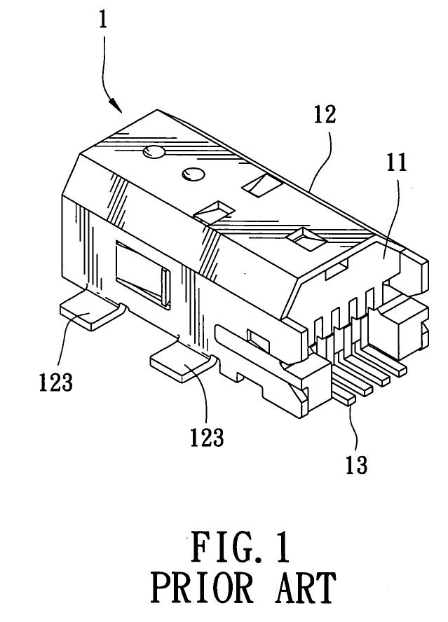

FIG. 2 is a front perspective view of the first preferred embodiment of a surface mountable electrical connector according to this invention;

FIG. 3 is a rear perspective view of the first preferred embodiment;

FIG. 4 is a rear view of the first preferred embodiment;

FIG. 5 is a bottom view of the first preferred embodiment;

FIG. 6 is a rear perspective view of the second preferred embodiment of the surface mountable electrical connector according to this invention; and

FIG. 7 is a side view of the second preferred embodiment.

### DETAILED DESCRIPTION OF THE PREFERRED EMBODIMENTS

Before the present invention is described in greater detail, it should be noted that same reference numerals have been used to denote like elements throughout the specification.

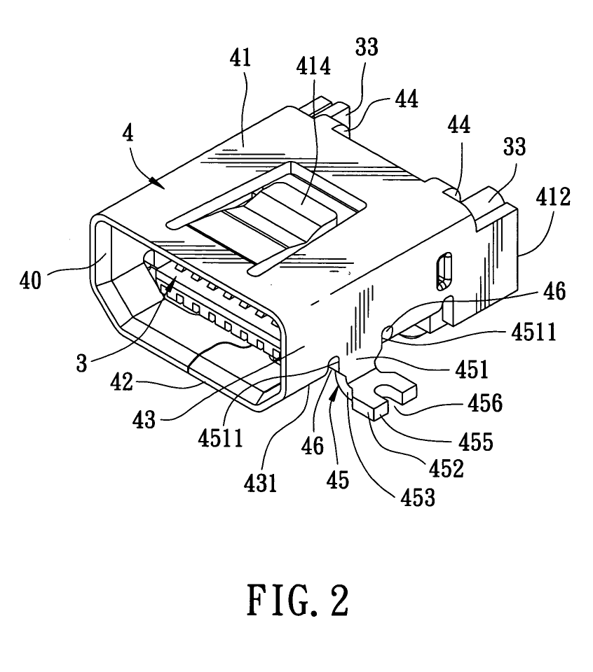

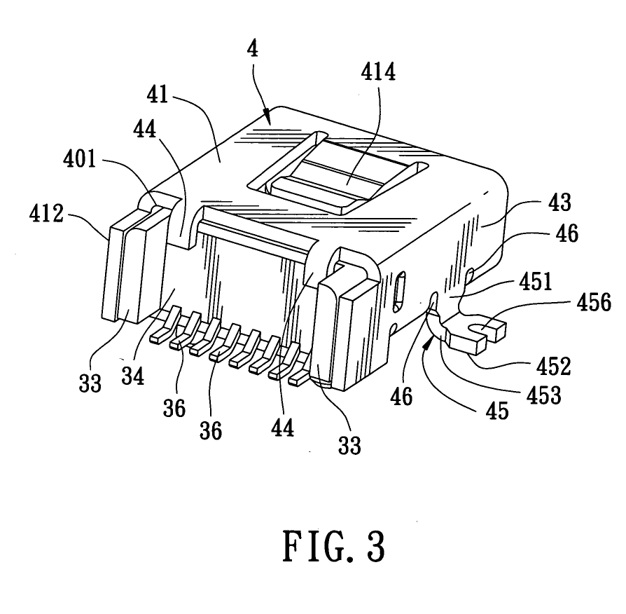

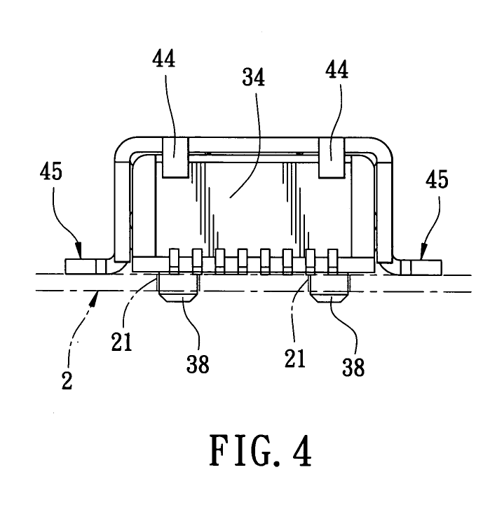

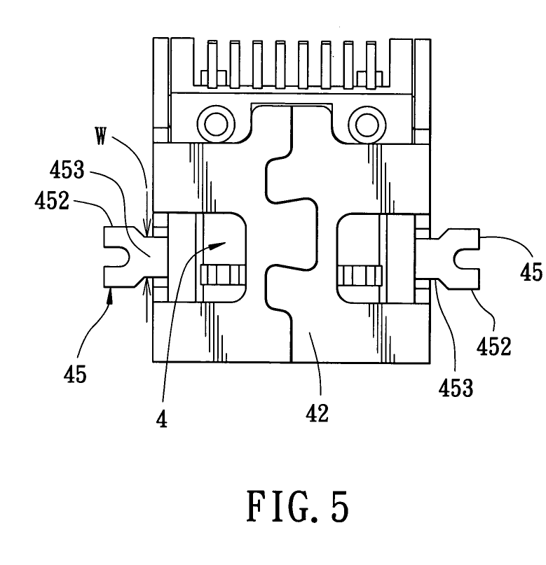

FIGS. 2 to 5 illustrate the first preferred embodiment of a surface mountable electrical connector according to the present invention. The surface mountable electrical connector is adapted to be surface mounted on a planar surface of a printed circuit board 2 (see FIG. 4), and includes: an insulative terminal housing 3; a plurality of conductive terminals 36 (see FIG. 3) mounted on the housing 3; and a shielding cover 4 surrounding the terminal housing 3 and having a plurality of L-shaped surface mounting legs 45 bent and extending outwardly therefrom. Each of the surface mounting legs 45 has a first segment 451 that extends in a transverse direction relative to the printed circuit board 2, a bent segment 453 that is bent from the first segment 451, and a second segment 452 that extends from the bent segment 451 and that is adapted to be parallel and soldered to the planar surface of the printed circuit board 2. The bent segment 453 has a width (W) (see FIG. 5) less than those of the first and second segments 451, 452. The second segment 452 has a free end 455 that is distal from the bent segment 453, and is bifurcated to define a recess 456 that extends inwardly from the free end 455 of the second segment 452. In this embodiment, the shielding cover 4 includes opposite top and bottom walls 41, 42 that are to be disposed parallel to the printed circuit board 2, and opposite left and right side walls 43 extending in the transverse direction, interconnecting the top and bottom walls 41, 42, and cooperating with the top and bottom walls 41, 42 to define an inner space 40 that receives the terminal housing 3 therein. The first segment 451 of each of the surface mounting legs 45 is integrally connected to and extends downwardly from a respective one of the left and right side walls 43. The shielding cover 4 is formed from a unitary metal sheet stamped in a predetermined shape and subsequently folded to form the top and bottom walls 41, 42, the left and right side walls 43, and the surface mounting legs 45.

Each of the left and right side walls 43 of the shielding cover 4 has a bottom end 431. The first segment 451 of each of the surface mounting legs 45 has opposite front and rear sides 4511, and cooperates with the respective one of the left and right side walls 43 to define a pair of opposite slits 46 at the front and rear sides 4511 of the first segment 451, respectively. The slits 46 extend inwardly from the bottom end 431 of each of the left and right side walls 43 in the transverse direction.

The top wall 41 of the shielding cover 4 is formed with a spring arm 414 that presses resiliently the terminal housing 3 to abut against the bottom wall 42 of the shielding cover 4.

The shielding cover 4 defines a rear opening 401. The terminal housing 3 has a rear wall 34 that extends outwardly of the rear opening 401. The shielding cover 4 is formed with a pair of L-shaped retaining tongues 44 that are bent downwardly from the top wall 41 of the shielding cover 4 and that abut against the rear wall 34 of the terminal housing 3. A plurality of positioning legs 38 are formed on and extend downwardly from the terminal housing 3 through the bottom wall 42 of the shielding cover 4 and into holes 21 in the printed circuit board 2, respectively.

Each of the left and right side walls 43 of the shielding cover 4 has a rear extension 412 extending rearwardly therefrom. The rear wall 34 of the terminal housing 3 has two opposite extensions 33 that extend rearwardly from two opposite sides of the rear wall 34, that confront respectively the rear extensions 412 of the left and right side walls 43 of the shielding cover 4, and that cooperatively define a space therebetween. The terminals 36 extend through the rear wall 34 of the terminal housing 3 and into the space between the extensions 33 of the terminal housing 3.

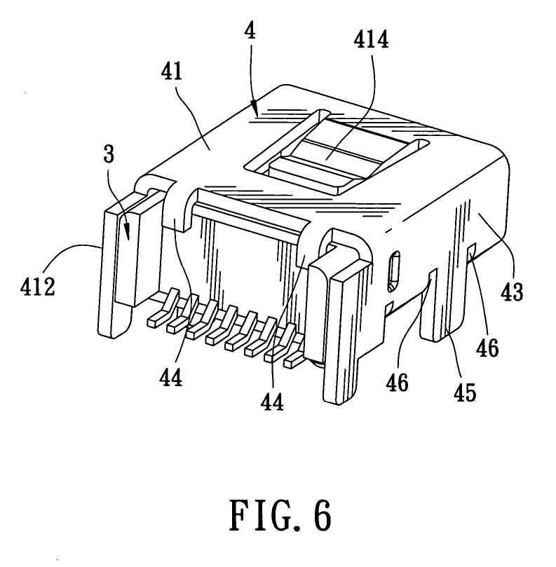

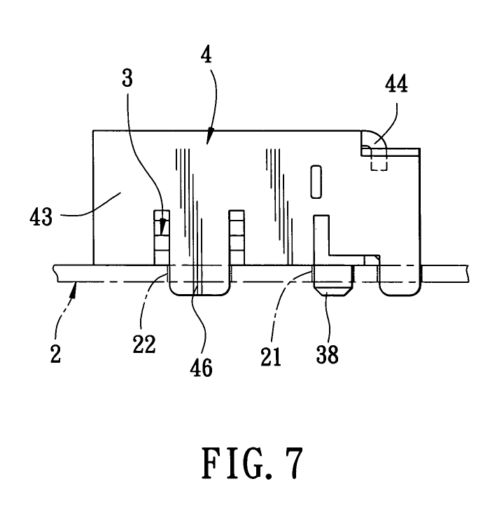

FIGS. 6 and 7 illustrate the second preferred embodiment of the surface mountable electrical connector according to this invention. The surface mountable electrical connector of this embodiment differs from the previous embodiment in that each of the surface mounting legs 45 is non-L-shaped and is straight instead. Each of the surface mounting legs 45 extends through a through-hole 22 in the printed circuit board 2. By virtue of the reduced width (W) of the bent segment 453 that is reduced from the first and second segments 451, 452, and the slits 46, the stress in each of the surface mounting legs 45, which results from bending of the surface mounting legs 45 from the metal sheet of the shielding cover 4, can be considerably decreased, thereby eliminating the aforesaid drawback with respect to the co-planarity problem encountered in the prior art. Moreover, since the perimeter along the side edge of each of the surface mounting legs 45 is increased as compared to that of the conventional electrical connector due to the formation of the recess 456 in the second segment 452 of each of the surface mounting legs 45, the amount of solder that can be soldered to each of the surface mounting legs 45 is significantly increased, thereby enhancing the bonding strength between the surface mountable electrical connector and the printed circuit board 2.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

1. A surface mountable electrical connector adapted to be surface mounted on a printed circuit board, said surface mountable electrical connector comprising:
an insulative terminal housing;
a plurality of conductive terminals mounted on said housing; and
a shielding cover surrounding said terminal housing and having a plurality of L-shaped surface mounting legs bent and extending outwardly therefrom, each of said surface mounting legs having a first segment that extends in a transverse direction relative to the printed circuit board, a bent segment that is bent from said first segment, and a second segment that extends from said bent segment and that is adapted to be parallel and soldered to a planar surface of the printed circuit board;
wherein said bent segment has a width less than those of said first and second segments; and
wherein said second segment has a free end that is distal from said bent segment, and is bifurcated to define a recess that extends inwardly from said free end of said second segment.

2. The surface mountable electrical connector of claim 1, wherein said shielding cover includes opposite top and bottom walls that are to be disposed parallel to the printed circuit board, and opposite left and right side walls extending in said transverse direction, interconnecting said top and bottom walls, and cooperating with said top and bottom walls to define an inner space that receives said terminal housing therein, said first segment of each of said surface mounting legs being integrally connected to and extending downwardly from a respective one of said left and right side walls, said shielding cover being formed from a unitary metal sheet stamped in a predetermined shape and subsequently folded to form said top and bottom walls, said left and right side walls, and said surface mounting legs.

3. The surface mountable electrical connector of claim 2, wherein each of said left and right side walls of said shielding cover has a bottom end, said first segment of each of said surface mounting legs having front and rear sides, and cooperating with the respective one of said left and right side walls to define a pair of opposite slits at said front and rear sides of said first segment, respectively, said slits extending inwardly from said bottom end of each of said left and right side walls in said transverse direction.

4. The surface mountable electrical connector of claim 2, wherein said top wall of said shielding cover is formed with a spring arm that presses resiliently said terminal housing to abut against said bottom wall of said shielding cover.

5. The surface mountable electrical connector of claim 2, wherein said shielding cover defines a rear opening, said terminal housing having a rear wall that extends outwardly of said rear opening, said shielding cover being formed with a pair of L-shaped retaining tongues that are bent downwardly from said top wall of said shielding cover and that abut against said rear wall of said terminal housing.
